(19) United States
(12) Patent Application Publication
(10) Pub. No.: US 2019/0250946 A1
(43) Pub. Date: Aug. 15, 2019

(54) MIGRATING A SOFTWARE CONTAINER TAKING INTO ACCOUNT RESOURCE CONSTRAINTS

(71) Applicant: International Business Machines Corporation, Armonk, NY (US)

(72) Inventors: Pradeep Parameshwaran, Boeblingen (DE); Marco Selig, Boeblingen (DE); Qais Noorshams, Boeblingen (DE); Utz Bacher, Dettenhausen (DE)

(21) Appl. No.: 15/895,578

(22) Filed: Feb. 13, 2018

(51) Int. Cl. G06F 9/48; G06F 9/50; G06F 9/455; G06F 8/71

(52) U.S. Cl. CPC G06F 9/4856; G06F 9/5088; G06F 2009/4557; G06F 9/45558; G06F 8/71; G06F 9/5077

(57) ABSTRACT

Provided is a method for determining a target host from a plurality of candidate hosts for migrating a software container. A management software component may instantiate a source agent software component on a source host and a target agent software component on each of a plurality of candidate target hosts. Resource requirements of at least one software container may be determined by the source agent software component. Resource capabilities of each of a plurality of target hosts may be determined by the target agent software components. The source agent software component may compare the resource requirements to the resource capabilities of each of the plurality of candidate target hosts. If the resource requirements are satisfied by a particular candidate target host, the particular candidate target host is assigned to be a target host. The at least one software container is migrated from the source host to the target host.

### BACKGROUND

The present disclosure relates generally to the field of virtualization, and more particularly to migrating software containers based on account resource constraints.

The present cloud infrastructure is operated by myriads of servers and processes. On such servers, in many cases, the software is organized to be executed on so-called software containers. The software containers may be executed on virtual machines. For maintenance tasks, a migration or relocation of a workload from one system or hypervisor to another is necessary from time to time.

### SUMMARY

Embodiments of the present disclosure include a method and computer program product for determining a target host from a plurality of candidate hosts for migrating a software container. A management software component may instantiate a source agent software component on a source host and a target agent software component on each of a plurality of candidate target hosts. Resource requirements of at least one software container may be determined by the source agent software component. Resource capabilities of each of a plurality of target hosts may be determined by the target agent software components. The source agent software component may compare the resource requirements to the resource capabilities of each of the plurality of candidate target hosts. In response to determining that the resource requirements are satisfied by a particular candidate target host, the particular candidate target host is assigned to be a target host. The at least one software container is then migrated from the source host to the target host.

Further embodiments of the present disclosure include a method for determining a migration plan for migrating a plurality of software containers from a source host to a plurality of target hosts. A management software component may instantiate a source agent software component on a source host and a target agent software component on each of a plurality of candidate target hosts. The source agent software component may measure resource requirements of the plurality of software containers. The target agent software components may measure resource capabilities of each of the plurality of candidate target hosts. A first migration plan for migrating the plurality of software containers to the plurality of target hosts may be determined. The first migration plan may include distributing each software container to a candidate target host having a least amount of resource capabilities available. If resource capabilities of the plurality of target hosts are sufficient to migrate the plurality of software containers to the plurality of candidate target hosts, the first migration plan may be executed. Executing the first migration plan may include assigning the candidate target hosts having the corresponding resource capabilities to be the target host and migrating at least one software container from the source host to the target host according to the first migration plan.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example data processing system adapted to implement the methods described herein, in accordance with embodiments of the present disclosure.

FIG. 2 illustrates migrating a software container from a source host to a target host, in accordance with embodiments of the present disclosure.

FIG. 3 illustrates an exemplary flowchart of a method for determining a target host for migrating a software container, in accordance with embodiments of the present disclosure.

FIG. 4 illustrates an exemplary flowchart of an overview of a method of migrating multiple software containers to several target hosts, in accordance with embodiments of the present disclosure.

FIG. 5 illustrates an initialization phase, in accordance with embodiments of the present disclosure.

FIG. 6 illustrates a measurement phase, in accordance with embodiments of the present disclosure.

FIG. 7 illustrates a preparation phase, in accordance with embodiments of the present disclosure.

FIG. 8 illustrates a migration phase, in accordance with embodiments of the present disclosure.

FIG. 9 illustrates a finalization phase, in accordance with embodiments of the present disclosure.

FIG. 10 illustrates a flowchart of a method of optimally preparing target hosts for migrating multiple software containers to the target hosts, in accordance with embodiments of the present disclosure.

FIG. 11 illustrates a flowchart of a method of optimally distributing software containers on target hosts, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present cloud infrastructure is operated by myriads of servers and processes. On such servers, the software is often organized to be executed on so-called software containers that are executed on virtual host software components or virtual hosts that are executed on hypervisors. The hypervisors may be executed on the server computer's hardware itself. This approach ensures that if an application fails in a way that its associated software container fails too, the whole system does not go down.

For maintenance tasks, a migration or relocation of a workload or a software container from one system to another system is necessary from time to time. Such migration or relocation is only successful when the resource constraints (e.g., CPU, memory, storage, etc.,) are met at the target system.

Presently, a system administrator manually or semi-automatically checks for the existence of such resource constraints. The system administrator then takes a snapshot of the running container in the host and saves the snapshot in a tar or a zip file. This can be downloaded at the target system and then be made to be executed thereupon. If the resource constraints are not met by the target system, the software containers might run into problems resulting in poor performance, stability, availability problems, or even worse.

Various embodiments provide for a computer implemented method for determining a target host of a multiplicity of candidate target hosts for reliably migrating a software container from a source host associated with a first hypervisor to the target host associated with a second hypervisor, a computer program product for determining a target host of a multiplicity of candidate target hosts for reliably migrating a software container from a source host associated with a first hypervisor to the target host associated with a second hypervisor, a computer implemented method for determining an optimal migration plan for reliably migrating a first multiplicity of software containers from a source host to a second multiplicity of target hosts, and a computer program product for determining an optimal migration plan for reliably migrating a first multiplicity of software containers from a source host to a second multiplicity of target hosts.

In one aspect, embodiments relate to a computer implemented method for determining a target host of a multiplicity of candidate target hosts for reliably migrating a software container from a source host associated with a first hypervisor to the target host associated with a second hypervisor, comprising: instantiating, by a management software component, a source agent software component on the source host and a target agent software component on each of the multiplicity of candidate target hosts; measuring, by the source agent software component, resource requirements of the at least one software container, thus obtaining required resources of the software container; measuring, by the target agent software components, resource capabilities of each of the multiplicity of candidate target hosts; comparing, by the source agent software component, the resource requirements with the resource capabilities of each of the multiplicity of candidate target hosts; if the resource requirements are met by at least one of the multiplicity of candidate target hosts: assigning the candidate target host having the corresponding resource capabilities to be the target host; and migrating the at least one software container from the source host to the target host.

In another aspect, embodiments relate to a computer program product for determining a target host of a multiplicity of candidate target hosts for reliably migrating a software container from a source host associated with a first hypervisor to the target host associated with a second hypervisor, the computer program comprising: a computer readable storage medium having computer usable code embodied therewith, wherein the computer readable storage medium is not a transitory signal per se, the computer usable program code comprising: computer usable code configured for instantiating, by a management software component, a source agent software component on the source host and a target agent software component on each of the multiplicity of candidate target hosts; computer usable code configured for measuring, by the source agent software component, resource requirements of the at least one software container, thus obtaining required resources of the software container; computer usable code configured for measuring, by the target agent software components, resource capabilities of each of the multiplicity of candidate target hosts; computer usable code configured for comparing, by the source agent software component, the resource requirements with the resource capabilities of each of the multiplicity of candidate target hosts; computer usable code configured for, if the resource requirements are met by at least one of the multiplicity of candidate target hosts: assigning the candidate target host having the corresponding resource capabilities to be the target host; and migrating the at least one software container from the source host to the target host.

In another aspect, embodiments relate to a computer implemented method for determining an optimal migration plan for reliably migrating a first multiplicity of software containers from a source host to a second multiplicity of target hosts, comprising: instantiating, by a management software component a source agent software component on the source host and a target agent software component on each of the second multiplicity of candidate target hosts; measuring, by the source agent software component, resource requirements of the first multiplicity of software containers; measuring, by the target agent software components, resource capabilities of each of the multiplicity of candidate target hosts; determining a first migration plan of the software containers of the first multiplicity of software containers to the second multiplicity of target hosts while distributing each software container to a candidate target host having the least amount of resource capabilities left; if all software containers of the first multiplicity of software containers are distributed to the second multiplicity of target hosts, executing the first migration plan by: assigning the candidate target hosts having the corresponding resource capabilities to be the target host; and migrating the at least one software container from the source host to the target host according to the first migration plan.

In another aspect, embodiments relate to a computer program product for determining an optimal migration plan for reliably migrating a first multiplicity of software containers from a source host to a second multiplicity of target hosts, the computer program product comprising: a computer readable storage medium having computer usable code embodied therewith, wherein the computer readable storage medium is not a transitory signal per se, the computer usable program code comprising: computer usable code configured for instantiating, by a management software component, a source agent software component on the source host and a target agent software component on each of the second multiplicity of candidate target hosts; computer usable code configured for measuring, by the source agent software component, resource requirements of the first multiplicity of software containers; computer usable code configured for measuring, by the target agent software components, resource capabilities of each of the multiplicity of candidate target hosts; computer usable code configured for determining a first migration plan of the software containers of the first multiplicity of software containers to the second multiplicity of target hosts while distributing each software container to a candidate target host having the least amount of resource capabilities left; computer usable code configured for, if all software containers of the first multiplicity of software containers are distributed to the second multiplicity of target hosts, executing the first migration plan by assigning the candidate target hosts having the corresponding resource capabilities to be the target host; and migrating the at least one software container from the source host to the target host according to the first migration plan. It is noteworthy that the target agent software component being executed on all of the second multiplicity of candidate target hosts may be implemented by one identical target agent software for all of the candidate target hosts.

Embodiments include a computer implemented method for determining a target host of a plurality of candidate target hosts for reliably migrating a software container from a source host associated with a first hypervisor to the target host associated with a second hypervisor. This may have an advantage in that a source host may be made free from software containers being executed thereupon so that maintenance work may be performed on the source host. A further advantage may be that an operator or administrator can be sure that the software container will be executed properly on the target host, because the operation may be executed reliably. A further advantage may be that, as the method is computer implemented, a reliable migration of a software container from a source host to a target host may be provided automatically. Thus, it is not necessary for an operator or an administrator to be concerned with the details of the migration. This may be in particular advantageous in administrating and/or maintaining larger data centers.

It is to be understood that the advantages described herein are example advantages and should not be construed as limiting. Embodiments of the present disclosure can contain all, some, or none of the described advantages while remaining within the spirit and scope of the present disclosure.

As used herein, a “virtual machine” may include an operating system that is installed on top of a specific virtualizing software, the virtualizing software enabling several operating systems to be installed in parallel on a hardware computer. The virtualizing software may be, for example, a hypervisor.

The term “container,” as used herein, may refer to a complete runtime environment of an application comprising anything that is necessary for the application to execute (e.g., program libraries, configuration files and all further necessary tools). By containerizing an application platform, differences concerning operating system and underlying infrastructure may be abstracted. Several containers may share and run on one operating system.

Generally, a virtual machine comprises a complete operating system, whereas a container carries an application and its necessary runtime environment. In specific examples it might be necessary to have a base operating system so that runtime and application may be built on top of it. Thus, a container can often be loaded and/or migrated much faster than a complete virtual machine. The effects of both are comparable: A software that is executed in one of a container or a virtual machine does not affect another container or virtual machine.

The term “host” as used herein is short for “virtual host” and, in particular, short for “virtual host software component.” The skilled person will appreciate that a host may include a software component such as, for example, an operating system, that is executed on a hypervisor running on a real (e.g., physical) hardware machine. In contrast, the host or virtual host software component only perceives to be executed on a real hardware machine, whereas, instead, the host in reality is executed on the hypervisor that provides the host with hardware resources.

The term “reliable” as used herein may refer in particular to the requirement to be sure that the migration of the software container from the source host to the target hosts has, as a result, the software container being provided, by the target host, with sufficient resources to be executed on the target host.

Embodiments of the present disclosure may further comprise instantiating, by a management software component (e.g., a container registry), a source agent software component on the source host and a target agent software component on each of the plurality of candidate target hosts. This may have an advantage in that the agent software components locally, on each host, may gather information or amend a configuration, which can be faster and more reliable than a centralized approach. Once the agent software components are instantiated, they may be executed each of its own.

Embodiments may further comprise measuring, by the source agent software component, resource requirements of the at least one software container, thus obtaining required resources of the software container. This may have an advantage in that the necessary information of the resources required by the software container to be migrated is gathered and held in place and may be provided upon request, if necessary.

The term “resource requirements of the software container to be migrated” or short: “resource requirements,” as used herein, may include the resources that are needed by the at least one software container to be migrated in order to execute the application in the software container.

The term “resources,” as used herein, may comprise, at least, colocation goals (e.g., groupings) of the containers to be migrated, hardware resources such as number of CPU's, amount of memory, bandwidth of network, average and/or maximum hardware resource consumption of all containers during a specific time interval t, topology identification, network distance and/or latency of hosts and hypervisor, relations between hypervisor and hosts, available and/or free resources on the hosts and hypervisors, among other things. The time interval t might be a maximum allowable time for the migration (e.g., the set time interval within which the migration should be completed).

Embodiments may further comprise measuring, by the target agent software components, resource capabilities of each of the plurality of candidate target hosts. This may have an advantage in that the necessary information concerning candidate target hosts is gathered and held in place and may be provided upon request, if necessary.

The term “resource capabilities of a target host” or short: “resource capabilities,” as used herein, may include the resources of the target that are available for a new container to be instantiated on the target host. Thus, the resource capabilities may include the free resources, as opposed to the total resources of the target host. This is because there may already other applications and/or containers be executed on the target host that has their own resource requirements to be fulfilled.

Embodiments may further comprise comparing, by the source agent software component, the resource requirements with the resource capabilities of each of the plurality of candidate target hosts. This may have an advantage in that information may be gathered as to which of the plurality of target hosts is able to receive the software container from the source host and reliably execute the software container without restrictions.

Embodiments may further comprise, if the resource requirements are met by at least one of the plurality of candidate target hosts: assigning the candidate target host having the corresponding resource capabilities to be the target host; and migrating the at least one software container from the source host to the target host. This may have an advantage in that, from the plurality of candidate target hosts, the target host may be selected. In other words, the software container may be migrated to the target host that is capable of receiving and executing the software container.

The term “assign” in “to assign a required resource from a hypervisor to a target host” as used herein in particular means that the respective resources are added or attached to the target host, such that after the assigning, the target host has the disposal of the resource.

The skilled person will understand that the terms “resource constraints” may preferably be understood to be equivalent to the term “required resources.”

According to embodiments, the method may comprise, if the resource requirements are met by none of the plurality of candidate target hosts: requesting, by at least one of the target agent software components, to assign the required resources from a hypervisor to at least one of the plurality of candidate target hosts; assigning the target host having the required resources attached to be the target host. This may have an advantage in that an originally inappropriate host (e.g., a host that originally lacks adequate resource attached to it to execute the software container), is made appropriate by adding the necessary resources and, thus, enabling it to receive and execute the software container.

Embodiments may further comprise migrating the at least one software container from the source host to the target host. This may have an advantage in that an administrator or operator can be sure that the software container may be executed appropriately.

According to embodiments, the step of measuring may comprise, by at least one of the target agent software components or the source agent software components, one or more of: identifying colocation goals of containers, identifying average and or maximum resource consumption of all containers during a given time t, identifying a topology of the concerned source host and target hosts, identifying available, or free, resources on the hosts and/or hypervisors. This may have an advantage in that the different aspects and parameters that may influence the resource situation of a candidate target host may be detected or measured. This may have a further advantage concerning the degree of freedom, which of the parameters might be due to be altered in order to find or preconfigure an appropriate target host.

A “group of containers” as used herein may refer in particular to several applications that are logically bound. For example, in a multi-tier application, each tier might be arranged to be executable within a separate software container. In such a multi-tier application, the communication structure between such software containers necessarily has to be maintained when migrated. This can be achieved by maintaining the group of containers collocated, for example, within one group. If this is not possible, communication infrastructure has to be configured accordingly in order to main the execution of the grouped application.

In this regard, a “subgroup” of a group of containers may mean a result of a splitting process in that the original group of software containers as being executed on the source host is split into at least two subgroups.

According to embodiments, the method may further comprise maintaining a grouping of containers on the source host to be grouped identically on the target host. This may have an advantage in that an informational infrastructure between the grouped software containers may be maintained when migrated. Such grouping might be advantageous, for example, in the case of multi-tier application where the several software components of the stack are arranged in separated containers.

According to embodiments, the method may further comprise, if the resource requirements are met by none of the plurality of candidate target hosts: configuring the candidate target hosts. This may have an advantage in that an administrator may be sure that the planned migration of the software container to the target host may be accomplished successfully while maintaining the software container to be executable on the target host.

According to embodiments, the method may further comprise, in the step of configuring the candidate target hosts: requesting a hypervisor to assign additional resources to at least one of the candidate target hosts. This may have an advantage in that the candidate host may be enabled, based on the added resources, to execute the software container.

According to embodiments, the method may further comprise, in the step of configuring the candidate target hosts: requesting a hypervisor to move at least one resource from one candidate target host on the hypervisor to another candidate host on the same hypervisor. This may have an advantage if the hypervisor does not have sufficient resources to allocate to a candidate target host, but a different candidate target host has free or unused resources. These free resources may be assigned to another candidate target host (along with or instead of free resources available to the hypervisor) so that the other target host gains sufficient resources in order to be able to receive the software container.

According to embodiments, the method may further comprise, in the step of configuring the candidate target hosts: splitting a group of software containers into subgroups. This may have an advantage in that, if there is no possibility to assign sufficient resources on one single candidate target host, the grouped software containers may nevertheless be migrated, though separated. In this case, it might be necessary for the respective agents to configure additional resources, install additional infrastructure, or affect appropriate configurations, so that the then separated software containers will be able to communicate with each other as before the migration. In other words, additional infrastructure or resources may be configured to allow the various migrated subgroups to communicate across VMs, hypervisors, or even physical host systems. A subgroup may comprise one or more software containers.

According to embodiments, the method may further comprise, in the step of configuring the candidate target hosts: migrating a workload software container that is being executed on a first one of the candidate target hosts to another candidate target host, thus releasing resources assigned to the first one of the candidate target hosts. Workload software container as used herein may include a software container that is already being executed on a candidate target host. In the case of a candidate target host that is not assigned sufficient resources, but would have sufficient resources if one workload software container would be relocated to another hypervisor without affecting the performance of the relocated workload container and without adversely affecting the performance of the other hypervisor, such workload software container might be relocated, thus releasing resource in favor of the software container that is to be migrated. In this regard it might be noted that the terms migration, placement, evacuation, relocation, or movement might be used, by the skilled person, equivalently and interchangeably, in regard of migration of a software container to a target system (e.g., a target host).

According to embodiments, if the resource requirements are met by none of the plurality of candidate target hosts, resources from one candidate target host on a hypervisor may be reassigned to another candidate target host on the same hypervisor. This may provide an advantage of flexibility. For example, if the hypervisor as a whole has sufficient resources, but the resources are distributed in a manner making a migration of the software container impossible, the resources may be redistributed between the candidate target hosts, thereby making the migration of the software container feasible.

According to embodiments, the first hypervisor and the second hypervisor may be identical. This may have an advantage when a hypervisor is provided with sufficient resources so that the software container may be migrated within one and the same hypervisor from the source host to the target host.

According to an aspect, a computer program product is envisaged for determining a target host of a plurality of candidate target hosts for reliably migrating a software container from a source host associated with a first hypervisor to the target host associated with a second hypervisor. This may have an advantage in that one or more of the aforementioned method steps, combined or not, can be made easily executable on different computer systems. Further advantages of the following features may be found above correspondingly.

In embodiments, the computer program product may comprise a computer readable storage medium having computer usable code embodied therewith. This may have an advantage in that the computer program product may be easily taken and transported to another destination computer system. It is to be understood that the computer readable storage medium is not a transitory signal per se.

In embodiments, the computer usable program code may comprise computer usable code configured for instantiating, by a management software component, a source agent software component on the source host and a target agent software component on each of the plurality of candidate target hosts.

In embodiments, the computer usable program code may comprise computer usable code configured for measuring, by the source agent software component, resource requirements of the at least one software container, thus obtaining required resources of the software container.

In embodiments, the computer usable program code may comprise computer usable code configured for measuring, by the target agent software components, resource capabilities of each of the plurality of candidate target hosts.

In embodiments, the computer usable program code may comprise computer usable code configured for comparing, by the source agent software component, the resource requirements with the resource capabilities of each of the plurality of candidate target hosts.

In embodiments, the computer usable program code may comprise computer usable code configured for, if the resource requirements are met by at least one of the plurality of candidate target hosts: assigning the candidate target host having the corresponding resource capabilities to be the target host; and migrating the at least one software container from the source host to the target host.

According to an aspect, a computer implemented method is envisaged for determining a migration plan for reliably (e.g., without causing performance impact) migrating a first plurality of software containers from a source host to a second plurality of target hosts. A migration plan (also referred to as an optimal migration plan) as used herein may refer to a migration plan enabling maximum resource utilization.

The method may further comprise instantiating, by a management software component, a source agent software component on the source host and a target agent software component on each of the second plurality of candidate target hosts. This may have an advantage in that the agent software components locally, on each single host, may gather information or amend a configuration, which may be faster and more reliable than a centralized approach. Once the agent software components are instantiated, they may be executed.

The method may further comprise measuring, by the source agent software component, resource requirements of the first plurality of software containers. This may have an advantage in that the necessary information of the resources required by the software container, that is to be migrated, is gathered and held in place and may be provided upon request, if necessary.

The method may further comprise measuring, by the target agent software components, resource capabilities of each of the plurality of candidate target hosts. This may have an advantage in that the necessary information concerning candidate target hosts is gathered and held in place and may be provided upon request, if necessary.

The method may further comprise determining a first migration plan of the software containers of the first plurality of software containers to the second plurality of target hosts while distributing each software container to a candidate target host having the least amount of resource capabilities left. During determining the migration plan, it may be necessary to check several migration scenarios comprising several different requests of resource allocation, resource release, relocation of workload containers, and so on. Thus, to establish the migration plan, the software containers may be virtually distributed on to the candidate target hosts. This may be repeated until the first migration plan is ready, meaning, it enables the migration of the software containers to the target hosts while maintaining the software containers in an executable state and while obeying the criterion of an acceptable (e.g., optimal) distribution. For example, an “optimal distribution,” as used herein, may include a distribution that causes a software container to migrate to a target host that has the least amount of resource capabilities available while still being able to host the software container. This may have an advantage in that the resources of the system are optimally used (e.g., few resources are left available and, therefore, idle).

The method may further comprise, if all software containers of the first plurality of software containers are distributed to the second plurality of target hosts, executing the first migration plan by: assigning the candidate target hosts having the corresponding resource capabilities to be the target host; and migrating the at least one software container from the source host to the target host according to the first migration plan.

According to embodiments, the method may comprise, if, on the second plurality of target hosts, resource capabilities are not sufficient: requesting to assign additional resources for at least one of the second plurality of target hosts; based on the assigned additional resources: determining a further migration plan of the software containers of the first plurality of software containers to the second plurality of target hosts while distributing each software container to a candidate target host having the least amount of resource capabilities left; and, if all software containers of the first plurality of software containers are distributed to the second plurality of target hosts, executing the further migration plan by: assigning the candidate target hosts having the corresponding resource capabilities to be the target host; and migrating the at least one software container from the source host to the target host according to the further migration plan.

In other words, if the first migration does not yield a migration that delivers executable software containers, the target agent software components will try to get more resources assigned from the hypervisors. On this basis, a new migration plan may be established. This may have an advantage in that, even if a first migration plan would effectively not be feasible (e.g., would leave a software container unable to operate, or only capable of operating with reduced performance), a further migration plan may be established that may be feasible or even optimized.

According embodiments, the method may comprise, for a preparation of the migration: translating, in at least one of the source agent software component and the agent software components, the migration plan into a task list comprising all tasks to by accomplished by the source agent software component and all target agent software components, wherein the task list includes check-points for mutual interactions between all of the agent software components for the case of dependencies; and migrating the task list to the source agent software component and all target agent software components. This may have an advantage in that each agent software component, be it the source agent software component or the target agent software component, may receive precise instructions as to what is to do and what is to be waited for. Thus, the whole migration may be executed in a synchronized manner, being sure that all dependency requirements are met.

According to an embodiment, the method may comprise each of the source agent software component and each single target agent software component processing the task list in order to determine its, respective, own tasks, dependencies, and checkpoints. This may have an advantage in that each agent software component establishes its own instruction sequence.

According to an embodiment, the method may comprise at least one target agent software component requesting a release of resources assigned to its host to its hypervisor, or requesting new resources for its host from its hypervisor. This may have an advantage in that the target agent software component manages the free resources on its host so that there may be sufficient resources for the software container to be executed.

According to an embodiment, the method may comprise: broadcasting, by the source agent software component and all of the target agent software components, completion of its respective tasks, and, waiting, by the source agent software component and all of the target agent software components, for the reception of completion notifications. This may have an advantage in that a cooperation between all the source agent software component and target agent software components is synchronized so that the intended effect of the migration plan may be achieved.

According to an embodiment, the method may comprise: broadcasting, by the source agent software component and all of the target agent software components, a notification of completion of the preparation. This may have an advantage in that, when all resources are assigned as necessary for successfully executing the migration plan, (e.g., the preparation of all of the target hosts is finished), a management component may receive the notification of completion of the preparation and start the migration. This may ensure that the migration will be successful because all resources are distributed as required.

According to an aspect, a computer program product is envisaged for determining an optimal migration plan for reliably migrating a first plurality of software containers from a source host to a second plurality of target hosts. This may have an advantage in that one or more of the aforementioned method steps, combined or not, can be made easily executable on different computer systems. Further advantages of the following features may be found above correspondingly.

In embodiments, the computer program product may comprise a computer readable storage medium having computer usable code embodied therewith. This may have an advantage in that the computer program product may be easily taken and transported to another destination computer system. It may be noteworthy that the computer readable storage medium is not a transitory signal per se. Advantages of the respective embodiments may be found above in the corresponding method steps.

In embodiments, the computer usable program code may comprise computer usable code configured for instantiating, by a management software component, a source agent software component on the source host and a target agent software component on each of the second plurality of candidate target hosts.

In embodiments, the computer usable program code may comprise computer usable code configured for measuring, by the source agent software component, resource requirements of the first plurality of software containers.

In embodiments, the computer usable program code may comprise computer usable code configured for measuring, by the target agent software components, resource capabilities of each of the plurality of candidate target hosts.

In embodiments, the computer usable program code may comprise computer usable code configured for determining a first migration plan of the software containers of the first plurality of software containers to the second plurality of target hosts while distributing each software container to a candidate target host having the least amount of resource capabilities left.

In embodiments, the computer usable program code may comprise computer usable code configured for, if all software containers of the first plurality of software containers are distributed to the second plurality of target hosts, executing the first migration plan by: assigning the candidate target hosts having the corresponding resource capabilities to be the target host; and migrating the at least one software container from the source host to the target host according to the first migration plan.

It is to be understood that “optimal,” “optimized,” and the like, as used herein, does not mean the best under all conditions. Instead, optimal may include any configuration, arrangement, plan, etc. that satisfies a set of rules, or satisfies the set of rules better than other configurations, arrangements, plans, etc. For example, a migration plan may include a set of rules that a software container must be migrated to 1) a host having sufficient resources to execute the software container, and 2) the selected host must have the least amount of computing resources of all hosts in the system that satisfy the first rule. Accordingly, if two hosts satisfy rule one (i.e., the first and second hosts have sufficient resources to execute the software container), and the first host has fewer computing resources than the second host, the “optimal migration plan” may include migrating the software container to the first host.

It is to be noted that the suggestions made herein may aim at an automatic migration of one or more software containers, being executed on a source host, to one or more target hosts. The suggestions made herein may also aim at a reliable migration of software containers, so that an administrator may be sure that a migration may be executed successfully. In this regard, as used herein, a successful migration of a software container from a source host to a target host may in particular mean that the software container was executable on the source host and will be equivalently executable on its target host. Further, the suggestions made herein may aim at optimally distributing software containers to target hosts, optimally meaning that as few resources as possible are used.

Embodiments include a method for optimized migration of containers from a source to at least one target system, wherein said source and said at least one target system are enhanced with “agents”, that may be understood to be a management or a monitoring component, comprising the steps of: generating of resource consumption data of said source system and said at least one target system; generating of topology data of said “source landscape and said at least one target landscape; providing a communication link between said source and said at least one target agents; calculating best matching configuration of said at least one target system based on resource consumption data of said source system and topology data of said source landscape of said at least one target landscape exchanged between by agents via said communication link; adapting said at least one target system configuration to said best matching configuration, if required; performing migration from said source to said best matching target of said at least one target system by using standard migration methods. Further is disclosed that the generating of consumption data may be a dynamic real-time online resource consumption.

Embodiments include a decentralized system of agents and a method for optimal migration of software containers and groups thereof and optimal configuration of virtual hosts while respecting dynamic resource requirements and constraints. One of the advantages of a decentralized system of agents may be that their respective tasks may be executed in parallel, thus saving overall execution time.

More specifically, provided is a decentralized system of agents and a method to migrate software containers and groups thereof from a source virtual host to one or multiple of potential target virtual hosts by dynamically analyzing the resources landscape of the virtual hosts as well as hypervisors and resource requirements of the software containers as well as other workloads and to dynamically configure the virtual hosts' and the hypervisors' resources as required by the software containers to optimize overall resource utilization with the help of the hypervisors before migrating the containers from source to target virtual hosts.

In detail: When a migration request is sent, a set of agents on the source and potential target hosts may be spawned. The agents may be able to analyze the resource consumption of the software containers and all other running or executing workloads as well as the topology of the environment and the available resources of the virtual hosts and the hypervisors. The resource and topology information may be used to find an optimized distribution of the software containers to the target virtual hosts and to potentially reconfigure the target virtual hosts such that the resources utilization is maximized. In this regard, resources may be added from the hypervisor or hypervisors to the virtual target hosts; resources may be moved between virtual hosts, atop the same hypervisor; and groups of software containers may be split into subgroups. Finally, when the configuration is performed or the migration plan has executed, then the software containers may be migrated to the target virtual hosts.

In accordance with an embodiment, provided is a computer implemented method for determining a target host of a plurality of candidate target hosts for reliably migrating a software container from a source host associated with a first hypervisor to the target host associated with a second hypervisor, comprises instantiating, by a management software component, a source agent software component on the source host and a target agent software component on each of the plurality of candidate target hosts. Subsequently, the source agent software component measures resource requirements of the at least one software container, thus obtaining required resources of the software container. Further, the target agent software components may measure resource capabilities of each of the plurality of candidate target hosts. Then, the source agent software component compares the resource requirements with the resource capabilities of each of the plurality of candidate target hosts. If the resource requirements are met by at least one of the plurality of candidate target hosts: the candidate target host having the corresponding resource capabilities is assigned to be the target host. And, the at least one software container may be migrated from the source host to the target host. The result may be an evacuated source host, so that it can undergo maintenance, upgrade, uninstallation, or similar activities.

A benefit of the present proposal may be that the target system or target systems may be pre-configured with the necessary resources before the migration takes place. This may reduce the system administrator's involvement compared to doing such task manually. Further, it may be easier to predict a possibility of success of migration before actually performing it. Further, risks of running into configuration and/or performance problems during and after the migration may be reduced.

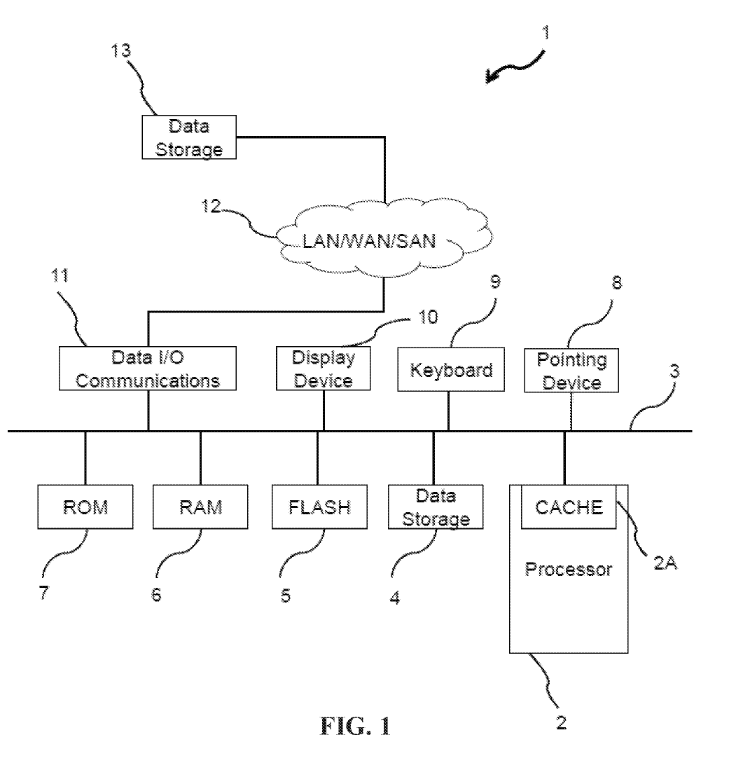

A block diagram illustrating an example computer processing system adapted to implement the methods of the present disclosure is shown in FIG. 1. The computer system 1, comprises a processor 2 which may comprise a digital signal processor (DSP), central processing unit (CPU), microcontroller, microprocessor, microcomputer, ASIC or FPGA core, and may include a cache 2A. The system 1 also comprises static read only memory 7 and dynamic main memory 6 and may also comprise a FLASH memory 5. The processor 2 is in communication with any of said memory devices, as well as with peripheral devices such as a display device 10, a keyboard 9, and a pointing device 8, such as, e.g., a mouse or a tablet, via a bus 3.

The computer system is connected to one or more external networks such as a LAN or WAN or SAN 12 via communications lines connected to the system via one or more data I/O communication interfaces 11, e.g. a network interface. The network adapters coupled to the system enable the data processing system to become coupled to other data processing systems or remote printers or storage devices through intervening public or private networks.

For example, in embodiments, a first computer that may be arranged as the data processing system as described with respect to FIG. 1, and a corporate data processing system that may be arranged as the data processing system as described with respect to FIG. 1 may be connected to each other so that the first computer can gain insight into the corporate data processing system. The corporate data processing system itself may be established by a plurality of second computers communicatively coupled to each other, each arranged as the data processing system as described with respect to FIG. 1, cooperating with one or more databases.

Modem, cable modem, and Ethernet cards are just a few of the currently available types of network adapters. The system 1 also includes a magnetic or semiconductor based data storage or storage device 4 and/or 13 for storing application programs and data. The system 1 comprises computer readable storage medium that may include any suitable memory means including, but not limited to, magnetic storage, optical storage, semiconductor volatile or non-volatile memory, or any other memory storage device.

In an exemplary embodiment, it may envisaged that the computer system that the user uses to communicate with the computer system that executes the method of present disclosure is a client computer system as depicted above. In another exemplary embodiment, it is envisaged that the computer system that executes the methods of the present disclosure essentially is structured comparable, however, in detail, as illustrated below.

In an exemplary embodiment it may be envisaged that a data center is established based on a plurality of computer systems similar to computer system 1.

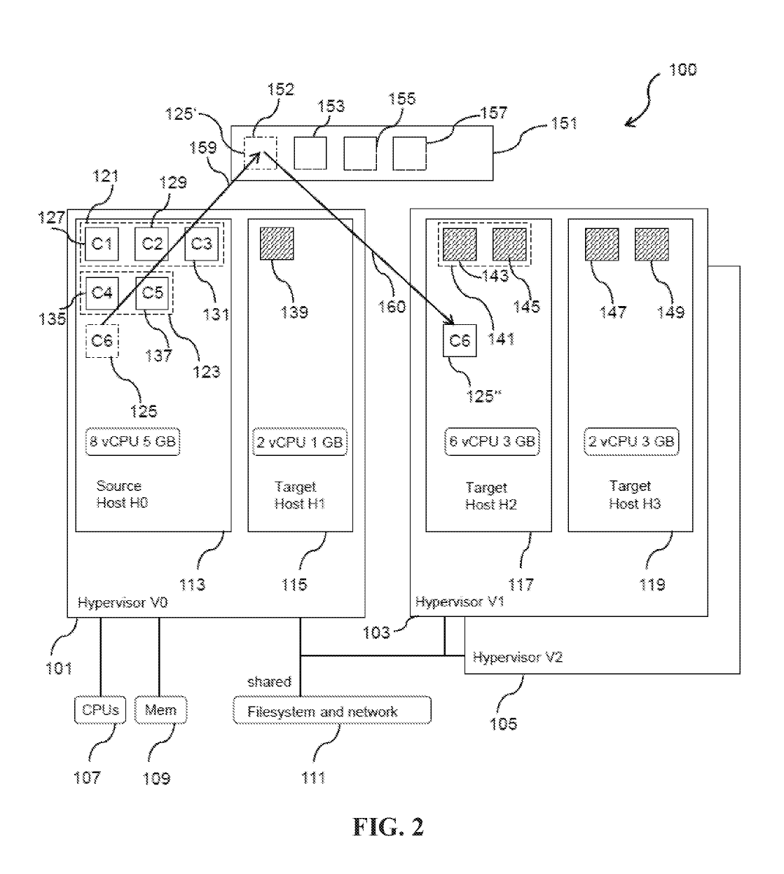

FIG. 2 illustrates an example of migrating a software container from a source host to a target host. A system 100 of computers 101, 103 and 105 is depicted, on each of which is being executed a hypervisor v0, v1, and v2 respectively. Hypervisor v0 is executed on computer 101 that is provided with several CPUs 107 and a certain amount of memory 109. The hypervisor v0 may be connected, through a shared filesystem and network 111, with hypervisor v1 being executed on computer 103 and with hypervisor v2 being executed on computer 105.

On hypervisor v0, two hosts are being executed, specifically source host h0 113, and target host h1 115. On hypervisor v1, the target hosts h2 117 and h3 119 are being executed. Source host h0 113 has assigned, by the underlying hypervisor v0, hardware resources of 8 (virtual) CPUs and 5 GB of memory. Target source h1 115 has assigned hardware resources of 3 CPUs and 1 GB of memory.

On source host h0 113, a group 121 of three software containers C1 127, C2 129, and C3 131, are installed or being executed. Further, on host h0 113, a second group 123 of two software containers C4 135 and C5 137 are installed. Further, on host h0 113 there is installed a software container C6 125. On target host h1 115, that in fact is a candidate target host, a workload software container 139 is installed.

On candidate target host h2 117, which has assigned hardware resources of 6 CPUs and 3 GB of memory, a group 141 of workload software containers 143 and 145 is installed. On candidate target host h3 119, which has assigned hardware resources of 2 CPUs and 3 GB of memory, two workload software containers 147 and 149 are being executed.

A container registry 151 may comprise entries 152, 153, 155, and 157 of registered containers on system 100. The container registry may also be used to store (e.g., to intermediately store) software containers for the purpose of migration. When the administrator of the system 100 wants to evacuate host h0 113 (for example for maintenance reasons), he might manually select, from the candidate target hosts 115, 117, 119, host h2 117 to be the target host for software container C6. He might then initiate software container C6 being registered, 159, in the container registry 151 at 125′, if not already done, and then move, 160, the software container C6 to the target host h2 117, so that the software container eventually will be executed at 125” on target host h2 117. The skilled person will be aware that for the reason of performance of the migration, the software container C6 may be packaged via a tar or a zip, then moved, 159, to the registry 151 and finally moved, 160, to the target host h2 117. In the above procedure, the administrator cannot be sure as to whether the resources of target host h2 are sufficient for adding software container C6 without adversely affecting the performance, etc., of the software containers 143, 145 and C6.

In other words, for planned migrations or evacuations, for example, existing containers need to be moved to one or more candidate target virtual hosts. Containers may have resources allocated to them, the amount of which can be changed or be due to change during runtime. Resources may include, e.g., CPU, memory (e.g., RAM), and/or storage resources. When running a virtual host on a hypervisor, the hypervisor is in charge of controlling adding and/or changing resources allocated to the host at runtime. When performing migration, the allocated constraints need to be respected: The destination system needs to be aware of and be prepared for the resource constraints. If the constraints are not met, the hypervisor needs to allocate and add the required resources.

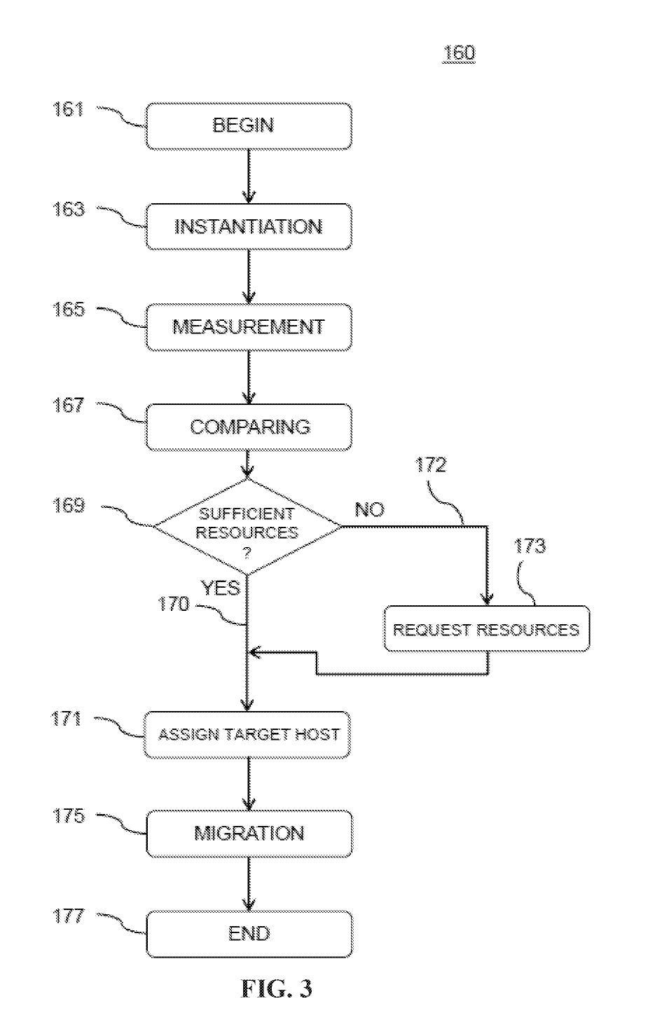

FIG. 3 illustrates an exemplary flowchart 160 of a method for determining a target host for migrating a software container, in accordance with embodiments of the present disclosure. The flow starts with begin operation 161, “BEGIN”, and continues by instantiating, at operation 163, “INSTANTIATION,” a source agent software component on the source host and a target agent software component on each of the plurality of candidate target hosts.

The step of measurement, 165, “MEASUREMENT,” symbolizes two steps of measurements: measuring, by the source agent software component, resource requirements of the at least one software container (e.g., the software container(s) to be migrated or currently executing), thus obtaining required resources of the software container. And measuring, by the target agent software components, resource capabilities of each of the plurality of candidate target hosts. In other words: The source agent software component measures what and how many resources the software container needs to be executable without being adversely affected, and the target agent software components measure what and how many resources are available on their respective candidate target hosts.

At step 167, “COMPARING,” the software container's resource requirements are compared with the available resources or resource capabilities of the candidate target hosts: comparing, by the source agent software component, the resource requirements with the resource capabilities of each of the plurality of candidate target hosts.

If, at decision block 169, “SUFFICIENT RESOURCES?”, the resource requirements are met by at least one of the plurality of candidate target hosts, 170: the candidate target host having the corresponding resource capabilities may be assigned, 171, “ASSIGN TARGET HOST”, to be the target host; and the at least one software container may be migrated, 175, “MIGRATION”, from the source host to the target host. Then the method may end, 177, “END.”

If, at decision block 169, the resource requirements are met by none of the plurality of candidate target hosts, 172, at least one of the target agent software components may request additional resources from its underlying hypervisor at operation 173, “REQUEST RESOURCES.” Then, the method may continue at operation 171 as already described. Alternatively, to be sure that there will be sufficient resources on the candidate target host, the method may again check, 169, as to whether the actual resources are sufficient, or, even, again perform, 165, by the target agent components, the process of measurements on the candidate target virtual hosts.

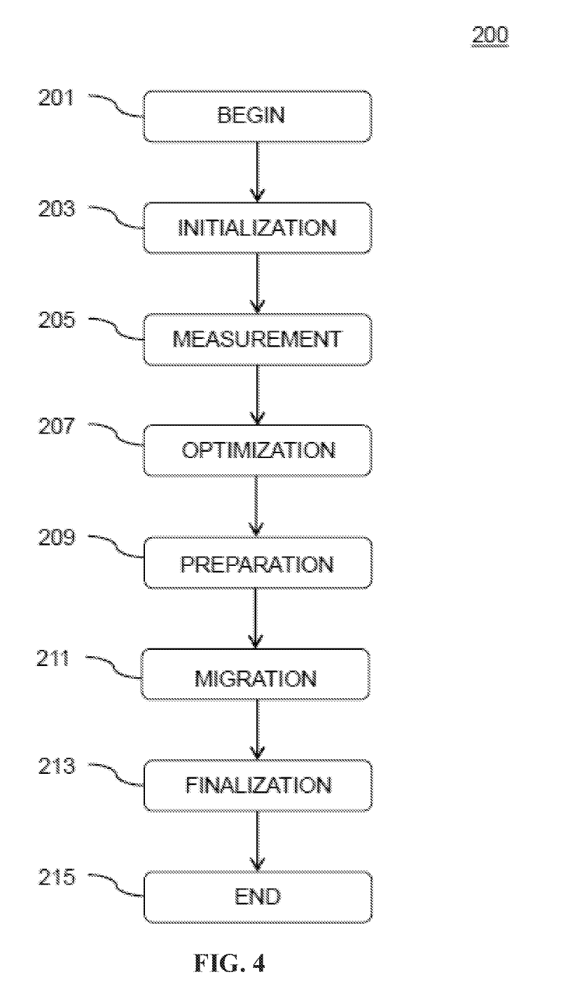

FIG. 4 illustrates an exemplary flowchart 200 of a method for optimally migrating multiple software containers to several target hosts, described herein. In step 201, “BEGIN,” a task might arrive in the computer system, to evacuate a specific source within a given time t.

In an initialization step 203, “INITIALIZATION,” a source agent software component will be activated or spawned on the source host and, on the plurality of candidate target hosts, target agent software components will be activated or spawned.

In a step of measurement, 205, “MEASUREMENT,” each of the agent software components may identify colocation goals (e.g., grouping requirements) of all containers. Further, the agents may identify average and/or maximum resource consumption or requirements of all containers during time t. Further, the agents may identify the underlying topology of hypervisors and hosts. This may be important in regard of network distance, latency of hosts, and relations between hypervisors and hosts. Further, available or free resources may be identified on the hosts and hypervisors. This may also concern dynamic resources, such as CPU and memory (RAM). Prerequisite may be the assumption of a shared file system and a given network infrastructure.

In step 207, “OPTIMIZATION,” the source agent software component may collect all involved information and solve the underlying optimization problem; for each container, the target host with optimal configuration (e.g., according to migration rules) may be identified. The optimization may be based on heuristics, e.g., a greedy optimization for NP-hard optimization problem to optimize resource utilization.

In step 209, “PREPARATION,” the agents may move resources between hosts or attach more resources from hypervisors to hosts, if needed.

In step 211, “MIGRATION,” the agents may initiate and perform the migration of containers and split groups of containers into subgroups, if needed.

In step 213, “FINALIZATION,” the target agent software components may signal to the source agent software component the completion of the container migration or relocation.

The method ends, “END,” in step 215, with the agents being shut down.

In the following, several stages and embodiments of the methods described herein will be explained with respect to the system 100 as depicted in FIG. 2. Like or similar reference numbers mean like or similar components. In particular, concerning components that have already been explained, the respective reference signs may be omitted for the reason of a better intelligibility of the following figures. In particular, an explanation of components already explained will not be repeated.

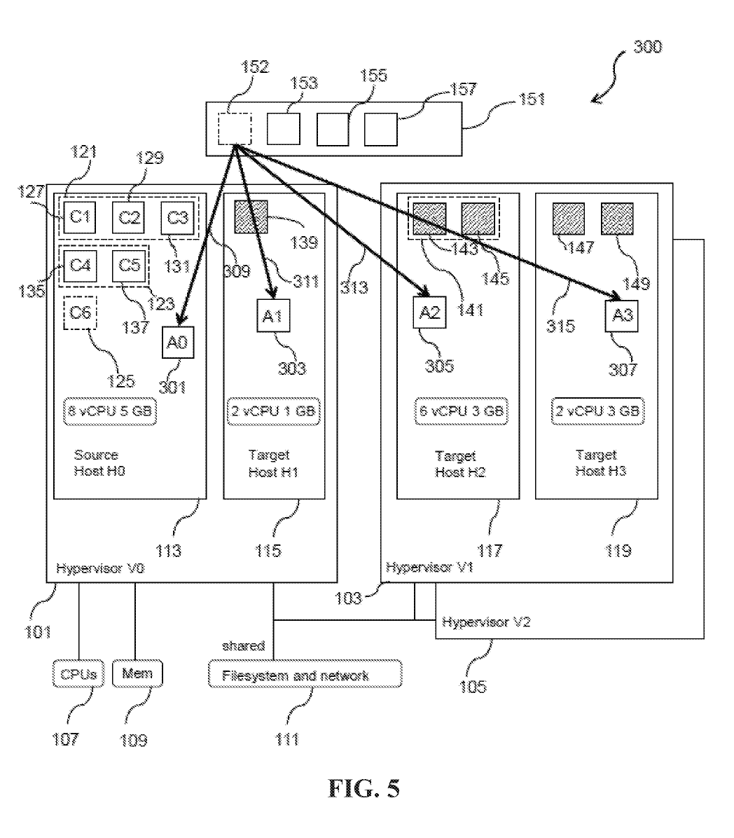

FIG. 5 illustrates an initialization phase 300 of embodiments described herein. Starting from the registry 151, when the task to evacuate host h0 113 within given time t has been entered to the system 1, a management component (e.g., the registry 151) may spawn or initiate agent software components. On the source host h0 113, a source agent software component A0 301 may be instantiated, 309. Further, on candidate target host h1 115, a target agent software component A1 303 may be instantiated, 311. Further, analogously, on candidate target hosts h2 117 and h3 119, target software agents A2 305 and A3 307 may be instantiated, 313, 315, respectively.

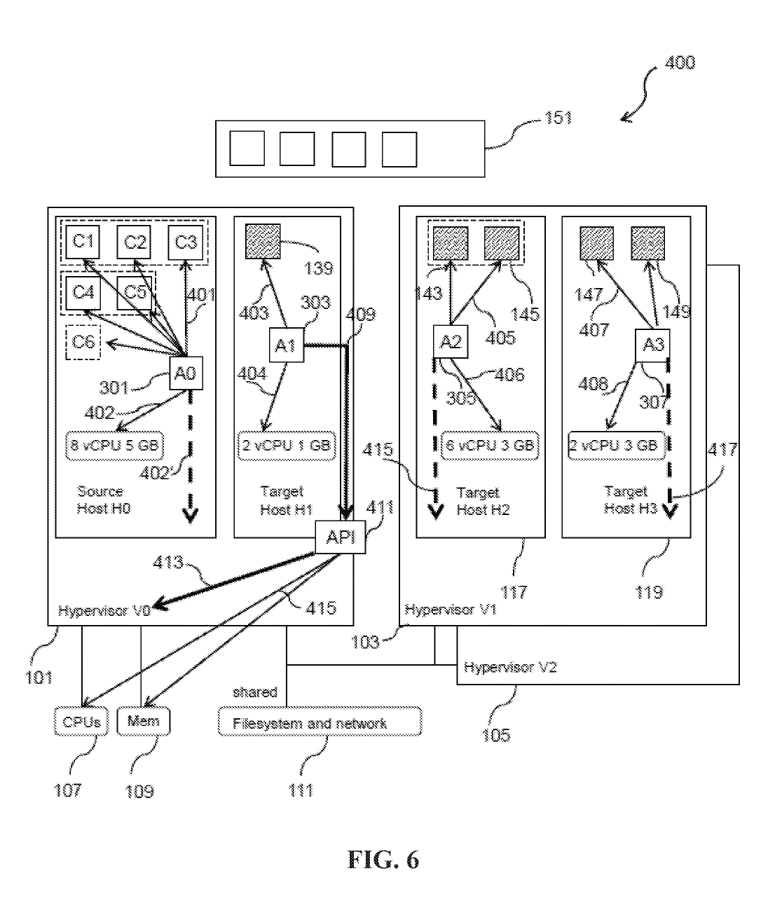

FIG. 6 illustrates a measurement phase 400 of embodiments described herein. Source agent software component A0 301 may measure, 401, the resource and colocation requirements of all of the software containers C1-C6 that are to be migrated. The source agent software component A0 may further measure, 402, the factual resources that are assigned to source host h0 113, and A0 may measure, 402′, the resources that are available at hypervisor v0 via an API (application programming interface) towards its underlying hypervisor v0.

Target agent software component A1 303, may measure, 403, the resource requirements of workload software container 139, identify or measure, 404, the resources that are assigned to candidate target host h1, and measure, 409, via API 411, the overall resources that hypervisor v0 may provide (e.g., by directing 413 the measurement through the API 411 indirectly to the hypervisor's h0 management, or by directly accessing 415, through API 411, the real hardware resources of CPUs 107 and memory 109). Based on these findings, target agent software component A1 may determine the free or available resources on candidate target host h1.

Target agent software component A2 305, may measure, 405, the resource requirements of the workload software container group consisting of software containers 143 and 145. Target agent software component A2 305 may further measure, 406, the resource assigned to candidate target host h2. Further, target agent software component A2 305 may measure 415, via the API of hypervisor v1, the overall hardware resources of hypervisor v1.

Analogously, target agent software component A3 307, may measure, 407, the resource requirements of the workload software containers 147 and 149. Target agent software component A3 307 may further measure, 408, the resource assigned to candidate target host h3. Further, target agent software component A3 307 may measure 417, via the API of hypervisor v1, the overall hardware resources of hypervisor v1.

It goes without saying that the agent software components A0 through A3 may also acquire topology information of the system.

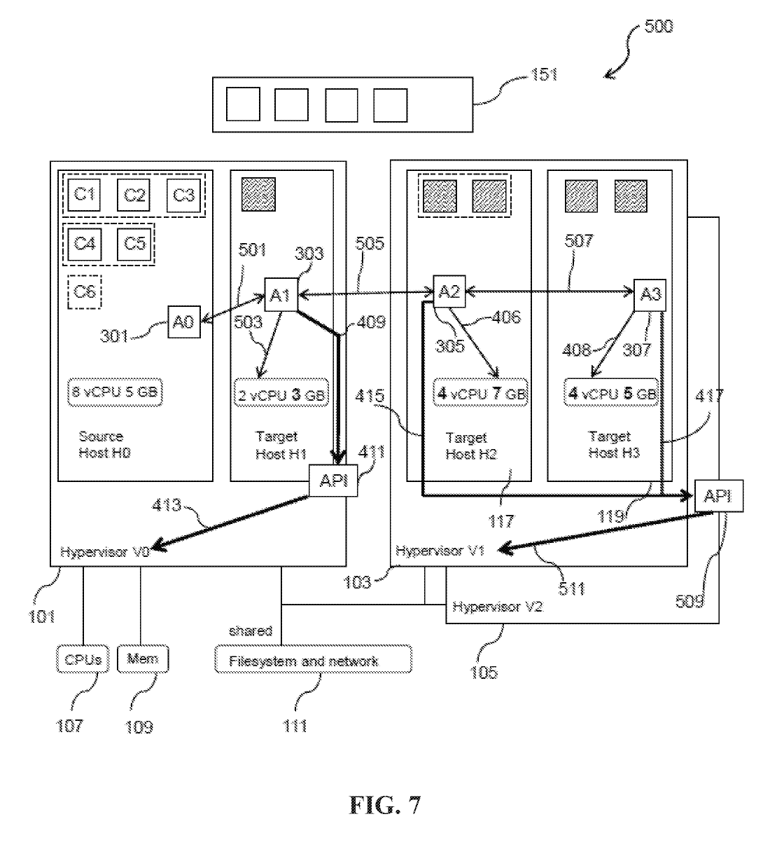

FIG. 7 illustrates a preparation phase 500 of embodiments described herein. When an optimal solution has been found, what will be described later, the source agent software component will communicate the optimal solution (e.g., the corresponding migration plan). This communication may be achieved by broadcasting it to all the target agent software components. The target software components may translate the overall migration plan to a local list of instructions and, in the case of dependencies, wait positions or checkpoints. Then each target agent software component may request resource modifications from its underlying hypervisor. Subsequently, the target agent software components may reconfigure their respective hosts by adding or shifting resources.

In detail: Source agent software component A0 301 determined a migration plan, be it optimal or not, and broadcasts it, 501, to target agent software component A1 303, broadcasts it, 505, to target agent software component A2 305, and, broadcasts it, 507, to target agent software component A3 307. In embodiments, the source agent software component A0 301 may be in direct communication with each target agent software component, and may broadcast the message directly to each target agent software component. In other embodiments, the message may be indirectly broadcast to each target agent software component (e.g., through various other components, such as other target agent software components, hypervisors, modules, etc.).

Likewise, each target agent software component may be in direct (or indirect) communication with all other target agent software components, as indicated by the broadcast indicating arrows 501, 505, and 507 being two-way arrows. This may be because, in case of dependencies, checkpoints requiring mutual communication between the agents may be necessary, as well as the completion signal that has to be issued to the source agent software component, so that it knows that the preparation of the resource distribution is finalized, and, then, the migration may be started.

Target agent software component A1 303 may alter, 503, in this example, the memory resource of candidate target host to be 3 GB instead of 1 GB. Target agent software component A2 305 may alter, 406, the resource assigned to host h2 to consist of 4 CPUs instead of 6 CPUs, and the memory to comprise 7 GB instead of 3 GB. Target agent software component A2 may achieve this by communicating, 415, via API 509, via 511, with hypervisor v1.

Target agent software component A3 307 may alter, 408, the resources assigned to host h3 to consist of 4 CPUs instead of 2 CPUs and the memory to comprise 5 GB instead of 3 GB. Target agent software component A3 may achieve this by communicating, 417, via API 509, via 511, with hypervisor v1.

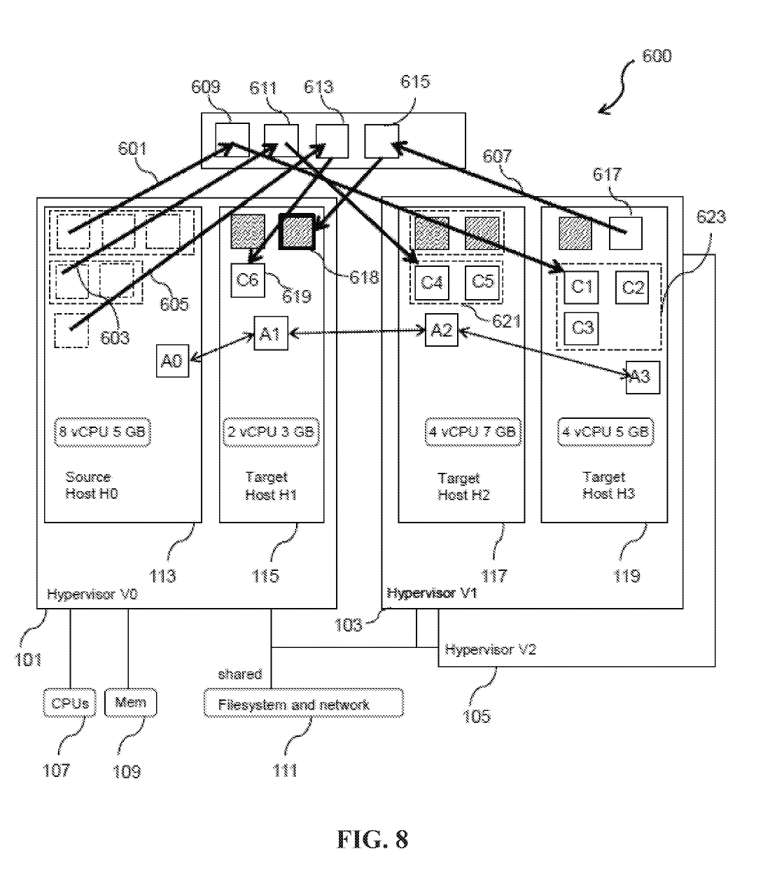

FIG. 8 illustrates a migration phase 600 of embodiments described herein. The source agent software component A0 will now, as the preparation of the target hosts is performed, freeze the containers C1 through C6, and store, 601, 603, and 605, their respective snapshots (e.g., of each group of containers, such as the first group consisting of C1, C2, and C3) in the registry slots 609, 611, and 613, respectively. The migration plan also requires that container 149, now 617, has to be migrated in order to free resources on target host h3. Thus, the target agent software component A3 will freeze the container 617 and store the respective snapshot at slot 615 of the registry.

Subsequently, each individual container may be redeployed: In this case, the grouping of software containers was not split, so the containers C1 through C3 are deployed to host 3 into group 623. The group consisting of containers C4 and C5 is migrated to group 621 on host h2, and software container C6 is deployed to host h1, on same hypervisor v0.

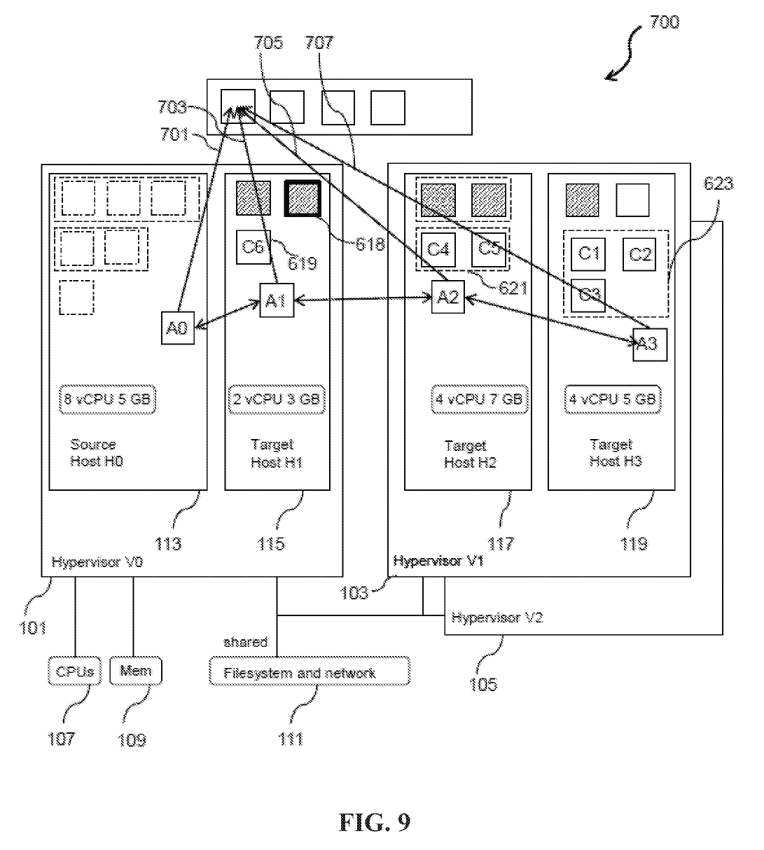

FIG. 9 illustrates a finalization phase 700 of embodiments described herein. The agents A0-A3 communicate (e.g., via broadcast) completion of the migration and will be stored, 701, 703, 705, 707, respectively, back to the registry.

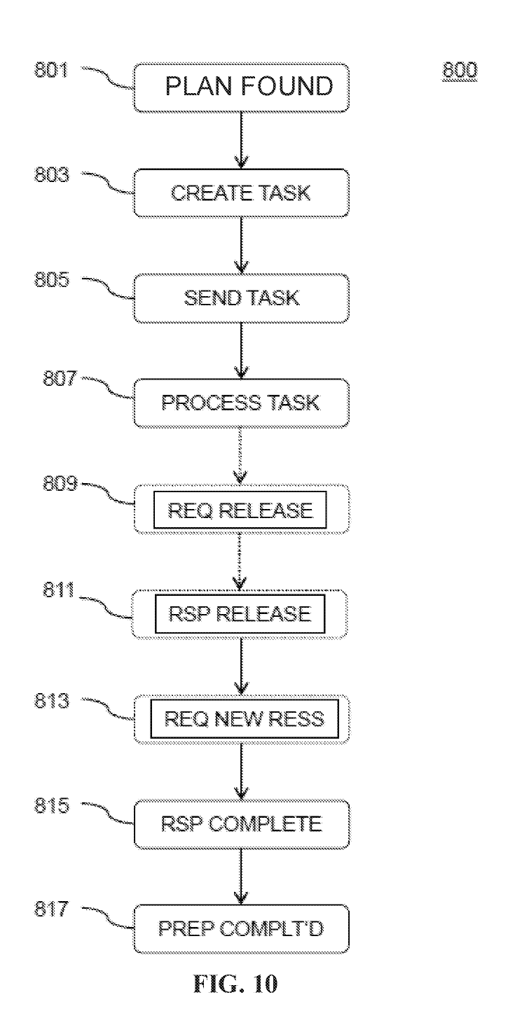

FIG. 10 illustrates a flowchart of an example method 800 for preparing target hosts for migrating multiple software containers to the target hosts, in accordance with embodiments of the present disclosure. In the case, one or more of the agent software components have computed a solution, 801, “PLAN FOUND.” In other words, the agent software components have generated a migration plan. This solution may be translated, 803, “CREATE TASK,” by the agents into a task list. The task list may include the tasks of all agents or agent software components, as well as check-points to wait at for completion signals of agents in case of dependencies. This task list may be sent, 805, “PROCESS TASK,” via broadcast, to all agents.

Each single agent software component may then process, 807, “PROCESS TASK,” the task list in order to determine its own tasks, dependencies, and check-points.

Optionally, if needed, agents may request, 809, “REQ RELEASE,” a release of resources assigned to their host on their hypervisor through an API. Upon completion, the agents may broadcast the completion of the release resource task, 811, “RSP RELEASE.” This signal may be associated with checkpoints.

Optionally, if needed, agents may request, 813, “REQ NEW RESS,” new resources for their respective hosts from their underlying hypervisor through an API.

Subsequently, the agents may broadcast, 815, “RSP COMPLETE,” the completion of tasks. Further, at this stage, all agents may await necessary completion notifications before continuing.

When, in 817, “PREP COMPLT′D,” the preparation is completed, which may notified by each single agent broadcasting completion of preparation, subsequently, the migration step may be performed.

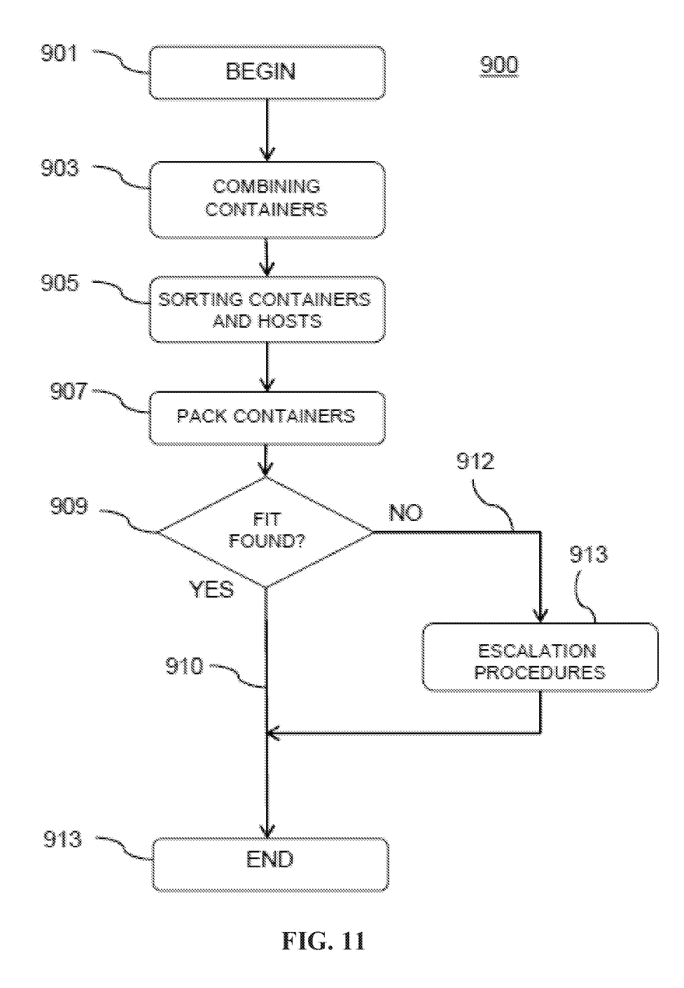

FIG. 11 illustrates a flowchart 900 of an example method for distributing software containers on target hosts. The method of optimally distributing software containers on target hosts may start with step 901, “BEGIN.”

In step 903, “COMBINING CONTAINERS,” the software containers may be combined with network communication into groups.

Subsequently, in step 905, “SORTING CONTAINERS AND HOSTS,” the containers and hosts may be sorted. For example, the containers and hosts may be sorted according to their CPU consumption and free CPU capacity, respectively. Among equals, containers and hosts may be sorted according to their memory consumption and free memory capacity, respectively. Further, the hosts may be sorted according to their latency to all other hosts.

In step 907, “PACK CONTAINERS,” the software containers may be packed into hosts that will have the least amount of resources left available. If a software container belongs to a previously split group, deployment preference may be given to the host with minimal latency between the group parts. In other words, a set of software containers that belonged to the same group prior to being split may be deployed such that communication between the various components in the set of software components will have minimal latency.

In decision block 909, “FIT FOUND?” it may be determined as to whether a fit for a software container has been found. If yes, it may be proceeded along 910 to 913, “END,” concerning this software container in question. If no fit, 912, for the software container in question is found, the method continues at 913, “ESCALATION PROCEDURES,” wherein several escalation procedures or escalation phases may be started: It may be evaluated as to whether a change of resources of the host by adding resources from the underlying hypervisor or moving resources from other hosts on the same hypervisor (sideby hosts) would make a fit possible. If a software container is a group, it may be split up and it may be continued at 907, “PACK CONTAINERS.” Space of a potential host may be freed up and re-distributed over other groups of containers—then it may be continued at 907, “PACK CONTAINERS.” If after all escalation phases, no fit is found and software container is not a group, the method may include either bringing up a new host or aborting the migration.

The optimization can, in text form, be described as follows. The problem formulation may be: Distribute software containers to hosts with the minimum number of hosts needed. The optimization problem is a variation of the (2D) bin packing problem, which is NP-hard. Thus, no efficient optimal solution may be possible.

Algorithm definitions:

Input

t: migration time

phi: element of {max, avg}: worst case/average consideration

Definitions

dᵢ: i-th software container

hₖ: k-th host machine

Calculated Values

c_{di}: CPU consumption of i-th software container

m_{di}: memory consumption of i-th software container

nᵢⱼ: element of {0,1}: network communication between i-th/j-th software container

p(hₖ, hₗ): network performance (latency) between k-th/l-th host

cₕₖ: available CPU resources on k-th host

mₕₖ: available memory resources on k-th host

Goal Function: Maximize resource utilization on virtual hosts. This may be done using the following steps:

Step 1: Combine software containers with network communication into groups: if nᵢⱼ=1 then dᵢ.

Step 2: Sort (or index) containers dᵢ and hosts hₖ. Sorting the containers and hosts may include several sub-steps. Sub-step (a): Sort both dᵢ and hₖ according to their CPU consumption c_{di} and free CPU capacity cₕₖ, respectively. Sub-step (b): Among equals, sort both dᵢ and hₖ according to their memory consumption m_{di} and free memory capacity mₕₖ, respectively. Sub-step (c): Further, sort hₖ according to their latency to all other hosts.

Step 3: Pack software container dᵢ into host hₖ that will have the least amount of resources left. If software container dᵢ belongs to a previously split group, give deployment preference to the host hₖ with minimal latency between the group parts.

If no fit for software container this found after step 3., use the following multiple escalation phases: (a) evaluate, if a change of resources cₕₖ and mₕₖ of the host hₖ by adding resources from i) the hypervisor or ii) sideby hosts (same hypervisor) would make fit possible. (b) if the software container is a group, then break up group and start at 3. (c) free up space of potential host or candidate target host hₖ by re-shuffling other groups of containers and start at 3. (d) if after all escalation phases no fit is found and software container is not a group, either bring up new host or abort.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method comprising:
instantiating, by a management software component, a source agent software component on a source host and a target agent software component on each of a plurality of candidate target hosts;
determining, by the source agent software component, resource requirements of at least one software container;
determining, by the target agent software components, resource capabilities of each of the plurality of candidate target hosts;
comparing, by the source agent software component, the resource requirements with the resource capabilities of each of the plurality of candidate target hosts;
assigning, in response to determining that the resource requirement are satisfied by a particular candidate target host of the plurality of candidate target hosts, the particular candidate target host to be a target host; and
migrating the at least one software container from the source host to the target host.

2. The method of claim 1, the method further comprising:
requesting, if the resource requirements are met by none of the plurality of candidate target hosts, to assign the required resources from a hypervisor to a particular candidate target host;
assigning the particular candidate target host to be the target host; and
migrating the at least one software container from the source host to the target host.

3. The method of claim 1, the method further comprising:
identifying colocation goals of containers;
identifying average or maximum resource consumption of all containers during a given time t;
identifying a topology of the source host and target hosts; and
identifying available resources on the candidate target hosts.

4. The method of claim 1, the method further comprising maintaining a grouping of containers on the source host to be grouped identically on the target host.

5. The method of claim 1, the method further comprising:
configuring, if the resource requirements are met by none of the plurality of candidate target hosts, the candidate target hosts.

6. The method of claim 5, wherein configuring the candidate target hosts comprises requesting a hypervisor to assign additional resources to at least one of the candidate target hosts.

7. The method of claim 5, wherein configuring the candidate target hosts comprises requesting a hypervisor to move at least one resource from one candidate target host on the hypervisor to another candidate target host on the same hypervisor.

8. The method of claim 5, wherein configuring the candidate target hosts comprises splitting a group of software containers into subgroups.

9. The method of claim 5, wherein configuring the candidate target hosts comprises migrating a workload software container that is being executed on a first one of the candidate target hosts to another candidate target host to release resources assigned to the first one of the candidate target hosts.

10. The method of claim 1, the method further comprising:
reassigning, if the resource requirements are met by none of the plurality of candidate target hosts, resources from one candidate target host on a hypervisor to another candidate target host on the same hypervisor.

11. A computer program product for reliably migrating a software container from a source host associated with a first hypervisor to the target host associated with a second hypervisor, the computer program comprising:
a computer readable storage medium having computer usable code embodied therewith, wherein the computer readable storage medium is not a transitory signal per se, the computer usable program code being configured to cause a processor to perform a method comprising:
instantiating, by a management software component, a source agent software component on a source host and a target agent software component on each of a plurality of candidate target hosts;
determining, by the source agent software component, resource requirements of at least one software container;
determining, by the target agent software components, resource capabilities of each of the plurality of candidate target hosts;
comparing, by the source agent software component, the resource requirements with the resource capabilities of each of the plurality of candidate target hosts;
assigning, in response to determining that the resource requirement are satisfied by a particular candidate target host of the plurality of candidate target hosts, the particular candidate target host to be a target host; and
migrating the at least one software container from the source host to the target host.

12. The computer program product of claim 11, wherein the method performed by the processor further comprises:
requesting, if the resource requirements are met by none of the plurality of candidate target hosts, to assign the required resources from a hypervisor to the particular candidate target host;
assigning the particular candidate target host to be the target host; and
migrating the at least one software container from the source host to the target host.

13. The computer program product of claim 11, wherein the method performed by the processor further comprises:
configuring, if the resource requirements are met by none of the plurality of candidate target hosts, the candidate target hosts,
wherein configuring the candidate target hosts includes requesting a hypervisor to move at least one resource from one candidate target host on the hypervisor to another candidate target host on the same hypervisor.

14. A computer implemented method for determining a migration plan for migrating a plurality of software containers from a source host to a plurality of target hosts, comprising:
instantiating, by a management software component, a source agent software component on the source host and a target agent software component on each of the plurality of candidate target hosts;
measuring, by the source agent software component, resource requirements of the plurality of software containers;
measuring, by the target agent software components, resource capabilities of each of the plurality of candidate target hosts;
determining a first migration plan for migrating the plurality of software containers to the plurality of target hosts, wherein the first migration plan includes distributing the plurality of software containers to a candidate target host having the least amount of resource capabilities available;
if resource capabilities of the plurality of target hosts are sufficient to migrate the plurality of software containers to the plurality of candidate target hosts, executing the first migration plan by:
assigning the plurality of candidate target hosts to be the target host; and
migrating at least one software container from the source host to the target host according to the first migration plan.

15. The method of claim 14, the method further comprising:
if resource capabilities of the plurality of target hosts are not sufficient, requesting to assign additional resources for at least one of the plurality of target hosts;
based on the assigned additional resources, determining a second migration plan of the plurality of software containers to the plurality of target hosts, the second migration plan including distributing each software container to a candidate target host having the least amount of resource capabilities left;
if all software containers of the plurality of software containers are distributed to the plurality of target hosts, executing the second migration plan by:
assigning the candidate target hosts having the corresponding resource capabilities to be the target host; and
migrating the at least one software container from the source host to the target host according to the second migration plan.

16. The method of claim 14, the method further comprising:
translating the migration plan into a task list comprising all tasks to by accomplished by the source agent software component and all target agent software components, wherein the task list includes check-points for mutual interactions between all of the agent software components for dependencies; and
migrating the task list to the source agent software component and all target agent software components.

17. The method of claim 16, the method further comprising:
processing, by the source agent software component and each target agent software component, the task list in order to determine its own tasks, dependencies, and checkpoints.

18. The method of claim 16, the method further comprising:
requesting, by at least one target agent software component, a release of resources assigned to its host to its hypervisor.

19. The method of claim 16, the method further comprising:
broadcasting, by the source agent software component and all of the target agent software components, completion of respective tasks; and
waiting, by the source agent software component and all of the target agent software components, for a notification of completion of the tasks.

20. The method of claim 16, further comprising:
broadcasting, by the source agent software component and all of the target agent software components, a notification of completion of the tasks.
